(19) United States
(12) Patent Application Publication
(10) Pub. No.: US 2024/0193358 A1
(43) Pub. Date: Jun. 13, 2024

(54) COMPUTER PROGRAM, SERVER DEVICE, TERMINAL DEVICE, AND METHOD

(71) Applicant: LEGALON TECHNOLOGIES, INC., Tokyo (JP)

(72) Inventor: Emiko Watanabe, Tokyo (JP)

(21) Appl. No.: 18/587,204

(22) Filed: Feb. 26, 2024

Related U.S. Application Data
(63) Continuation of application No. PCT/JP2021/031490, filed on Aug. 27, 2021.

(51) Int. Cl. G06F 40/186

(52) U.S. Cl. CPC G06F 40/186

(57) ABSTRACT

The present disclosure involves: selecting one related first article from among a plurality of first articles included in a template for at least one of a plurality of second articles included in an inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and determining, for at least one of the plurality of second articles included in the inspection target document, the registration-related information associated with the selected one related first article as information to be displayed on the subject terminal device.

### CROSS-REFERENCE TO RELATED APPLICATIONS

The present application is a continuation application of International Application No. PCT/JP2021/031490, filed on Aug. 27, 2021, which is expressly incorporated herein by reference in its entirety.

### BACKGROUND

### Technical Field

The technology disclosed in the present application relates to a computer program, a server device, a terminal device, and a method for supporting agreement creation.

### Related Art

A method for supporting document creation is disclosed in Japanese Patent Publication No. 2020-13524 A (Patent Literature 1). An information processing device described in this literature analyzes an article included in an agreement, and displays a warning or the like prepared in advance in association with a predetermined condition when the article does not satisfy the condition. Note that Patent Literature 1 is incorporated herein by reference in its entirety.

### SUMMARY

A computer program product according to an aspect “is embodying computer readable instructions stored on a non-transitory computer-readable storage medium for causing a computer to execute a process by at least one processor so as to perform the steps of: selecting one related first article from among a plurality of first articles included in a template for at least one of a plurality of second articles included in an inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and determining, for at least one of the plurality of second articles included in the inspection target document, the registration-related information associated with the selected one related first article as information to be displayed on the subject terminal device”.

### BRIEF DESCRIPTION OF THE DRAWINGS

FIG. 1 is a block diagram illustrating an example of a configuration of a document creation system according to an embodiment.

FIG. 2 is a block diagram schematically illustrating an example of a hardware configuration of a terminal device 20 (or a server device 30) illustrated in FIG. 1.

FIG. 3 is a flowchart illustrating an example of an operation executed in the document creation system illustrated in FIG. 1.

FIG. 4 is a schematic diagram illustrating an example of a screen displayed by a terminal device 20A included in the document creation system illustrated in FIG. 1.

FIG. 5 is a schematic diagram illustrating another example of a screen displayed by a terminal device 20A included in the document creation system illustrated in FIG. 1.

FIG. 6 is a diagram for conceptually explaining an example of an inspection performed on an inspection target document in the document creation system illustrated in FIG. 1.

FIG. 7 is a schematic diagram illustrating still another example of a screen displayed by the terminal device 20A included in the document creation system illustrated in FIG. 1.

### DESCRIPTION

The various systems, methods, and devices described herein are not to be construed as being limited in any way. The present disclosure is directed to all novel features and aspects of each of the various embodiments disclosed herein, combinations of the various embodiments, and combinations of some of the various embodiments. The various systems, methods, and devices described herein are not limited to particular aspects, features, or combinations of such particular aspects and features, and the articles and methods described herein do not require that there be one or more particular effects or problems be solved. Moreover, various features or aspects of the various embodiments described herein, or some of such features or aspects, may be used in combination.

Although the operations of some of the various methods disclosed herein are described in a particular order for convenience, it should be understood that description in this manner includes rearranging the above-described operations unless the particular order is required by a particular sentence below. For example, the plurality of operations described in order are, in some cases, rearranged or performed simultaneously. Furthermore, for purposes of simplicity, the accompanying drawings do not depict various ways in which the various items and methods described herein may be used in conjunction with other items and methods.

The operational theories, scientific principles, or other theoretical descriptions presented herein in connection with the devices or methods of the present disclosure are provided for the purpose of better understanding and are not intended to limit the technical scope. The devices and methods in the appended claims are not limited to devices and methods that work in accordance with such operational theories.

Any of the various methods disclosed herein may be implemented using a plurality of computer-executable instructions stored on one or more computer-readable media, and further executed in a computer. The one or more media may be, for example, non-transitory computer-readable storage media, such as at least one optical media disk, a plurality of volatile memory components, or a plurality of non-volatile memory components. Here, the plurality of volatile memory components include, for example, a DRAM or an SRAM. In addition, the plurality of nonvolatile memory components include, for example, a hard drive and a solid state drive (SSD). Further, the computer includes any computer available on the market, including, for example, a smartphone and other mobile devices having hardware for performing calculations.

Together with any data generated and used during implementation of the various embodiments disclosed herein, any of the plurality of computer-executable instructions for implementing the technology disclosed herein may be stored on one or more computer-readable media (e.g., non-transitory computer-readable storage media). The plurality of computer-executable instructions may be, for example, part of a separate software application, or part of a software application that is accessed or downloaded via a web browser or another software application (such as a remote computing application). Such software may be executed, for example, in a network environment (e.g., the Internet, a wide area network, a local area network, a client-server network (such as a cloud computing network), or another similar network) on a single local computer (for example, as a process executed on any suitable computer available on the market) or using one or more network computers.

For clarity, among various software-based implementations, particularly selected several aspects will only be described. Other details well known in the art will be omitted. For example, the technology disclosed herein is not limited to particular computer languages or programs. For example, the technology disclosed herein may be executed by software written in C, C++, Java (registered trademark), or any other suitable programming language. Similarly, the technology disclosed is not limited to a particular computer or a particular type of hardware. The specific details of the suitable computer and hardware are well known and do not need to be described in detail herein.

Furthermore, any of the various embodiments based on such software (including, for example, a plurality of computer-executable instructions for causing a computer to execute any of the various methods disclosed herein) may be uploaded or downloaded by a suitable communication means or accessed in a remote manner. Such a suitable communication means includes, for example, the Internet, the World Wide Web, an intranet, a software application, a cable (including an optical fiber cable), magnetic communication, electromagnetic communication (including RF communication, microwave communication, and infrared communication), electronic communication, or another similar communication means.

Hereinafter, various embodiments of the present disclosure will be described with reference to the accompanying drawings. Additionally, components common between the drawings may be denoted by the same reference signs. In addition, it should be noted that a component illustrated in a certain drawing may be omitted in another drawing for convenience of description. Furthermore, it should be noted that the accompanying drawings are not necessarily drawn to scale.

### 1. Example of Document Creation System

The information processing device disclosed in Patent Literature 1 displays a warning or the like prepared in advance in association with an article included in an agreement to be analyzed. However, a matter to be noted concerning the agreement to be analyzed may vary for each user, and may change over time for the same user.

Therefore, in view of such a problem or various other conceivable problems, the technology disclosed in the present application provides a computer program, a server device, a terminal device, and a method for supporting agreement creation while improving convenience in a broad sense.

Briefly speaking, a document creation system according to an embodiment is a system that provides a service for supporting document creation (hereinafter referred to as a “document creation service”) to a user via at least one information processing device.

The document creation system can store a template corresponding to each of a plurality of agreements in advance, and can cause the information processing device (e.g., a terminal device) of the user to edit these templates. For example, the user can select at least one template among the plurality of templates prepared in advance, and register at least one piece of related information (for example, typically, one piece of related information is “a comment”, and another piece of related information is “another example of article”) related to at least one article included in the selected template using the terminal device. The related information registered by the user in this manner may comprise a so-called review policy of the user.

The document creation system can inspect an inspection target document by comparing the template reflecting the review policy of the user with the inspection target document selected by the user.

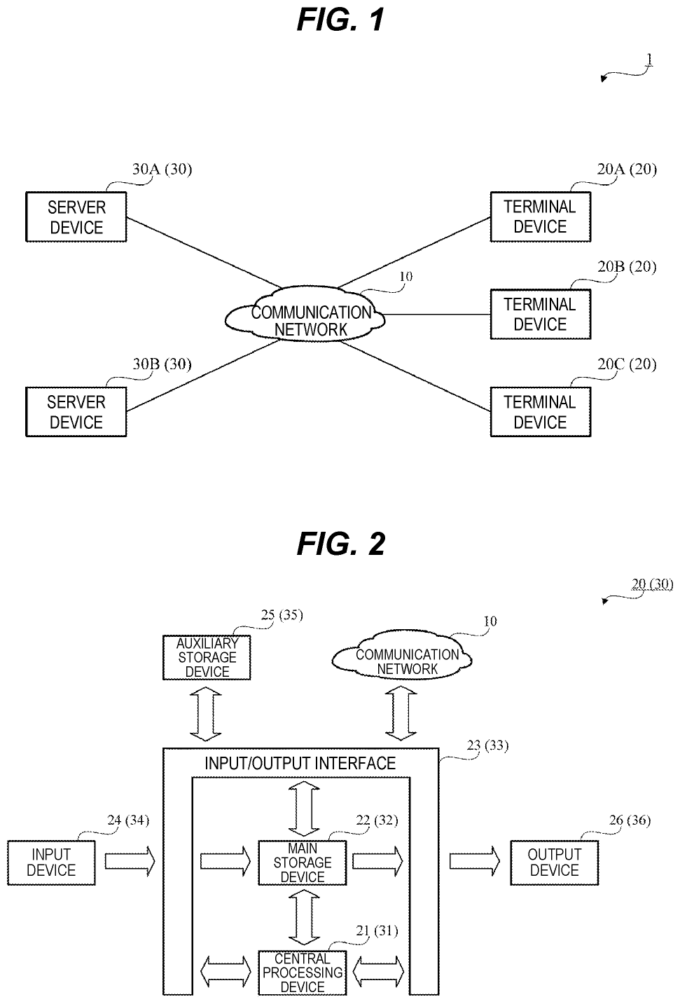

FIG. 1 is a block diagram illustrating an example of a configuration of a document creation system according to an embodiment. As illustrated in FIG. 1, the document creation system 1 can include one or more terminal devices (information processing devices) 20 that can be connected to a communication network (communication line) 10 and one or more document creation server devices (information processing devices) 30 that can be connected to the communication network 10.

In FIG. 1, three terminal devices 20A to 20C are exemplified as the one or more terminal devices 20, and two server devices 30A and 30B are exemplified as the one or more document creation server devices 30. However, one or more terminal devices 20 other than the above-described ones can be connected to the communication network 10 as the one or more terminal devices 20, and one or more server devices 30 other than the above-described ones can be connected to the communication network 10 as the one or more document creation server devices 30.

The communication network 10 can include, a cellular phone network, a wireless network, a fixed phone network, the Internet, an intranet, a local area network (LAN), a wide area network (WAN), and/or an Ethernet (registered trademark) network. For example, the wireless network can include RF connectivity via Bluetooth (registered trademark), WiFi (such as IEEE 802.11a/b/n), WiMax, cellular, satellite, laser, or infrared.

The terminal device 20 can be provided with the “document creation service” by executing at least one specific application and communicating with the document creation server device 30. The specific application can include a web browser, an operating system, and/or a dedicated application prepared for the service.

The terminal device 20 is any terminal device (information processing device), and can include a smartphone, a tablet, a mobile phone (feature phone), a personal computer, and/or a workstation.

The document creation server device 30 can provide a document creation service to the terminal device 20 by executing the installed specific application and functioning as a web server or an application server. The specific application can include an operating system and/or a dedicated application specially prepared for the service.

The document creation server device 30 is any information processing device, and can include a personal computer, a workstation, a mainframe, and/or a supercomputer.

### 2. Hardware Configuration of Each Device

An example of a hardware configuration of each of the terminal device 20 and the document creation server device 30 will be described.

### (1) Hardware Configuration of Terminal Device 20

The example of the hardware configuration of the terminal device 20 will be described with reference to FIG. 2. FIG. 2 is a block diagram schematically illustrating an example of a hardware configuration of the terminal device 20 (or the server device 30) illustrated in FIG. 1 (Note that, in FIG. 2, reference signs in parentheses are described in relation to the server device 30 as described later).

As illustrated in FIG. 2, the terminal device 20 can include a central processing device 21, a main storage device 22, an input/output interface device 23, an input device 24, an auxiliary storage device 25, and an output device 26. These devices are connected to each other by a data bus and/or a control bus.

The central processing device 21, which is a processor, may be referred to as a “central processing unit (CPU)”, and can perform an operation on an instruction and data stored in the main storage device 22 and store a result of the operation in the main storage device 22. Furthermore, the central processing device 21 can control the input device 24, the auxiliary storage device 25, the output device 26, and the like via the input/output interface device 23. The terminal device 20 can include one or more central processing devices 21.

The main storage device 22 may be referred to as a “memory”, and can store instructions and data received from the input device 24, the auxiliary storage device 25, the communication network 10, and the like (the server device 30 and the like) via the input/output interface device 23, and an operation result of the central processing device 21. The main storage device 22 can include a computer-readable medium such as a volatile memory (e.g., a register, a cache, or a random access memory (RAM)), a non-volatile memory (e.g., a read-only memory (ROM), an EEPROM, or a flash memory), and a storage (e.g., a hard disk drive (HDD), a solid state drive (SSD), a magnetic tape, or an optical medium). As will be readily appreciated, the term “computer-readable recording medium” can include a medium for data storage, such as a memory and a storage, rather than a transmission medium, such as a modulated data signal, that is, a transitory signal.

The auxiliary storage device 25 may be a storage device having a larger capacity than the main storage device 22. The auxiliary storage device 25 can store instructions and data (computer programs) comprising the specific application or the like, and can be controlled by the central processing device 21 to transmit the instructions and data (computer programs) to the main storage device 22 via the input/output interface device 23. The auxiliary storage device 25 can include a magnetic disk device and/or an optical disk device.

The input device 24 is a device that takes data from the outside, and can include a keyboard, a touch panel, a button, a mouse, and/or a sensor (a microphone or a camera).

The output device 26 can include a display device, a touch panel, and/or a printer device.

In such a hardware configuration, the central processing device 21 can sequentially load the instructions and data (computer programs) comprising the specific application stored in the auxiliary storage device 25 into the main storage device 22 and operate the loaded instructions and data. Accordingly, the central processing device 21 can control the output device 26 via the input/output interface device 23, or can transmit and receive various types of information (data) to and from another device (e.g., the server device 30 or the like) via the input/output interface device 23 and the communication network 10.

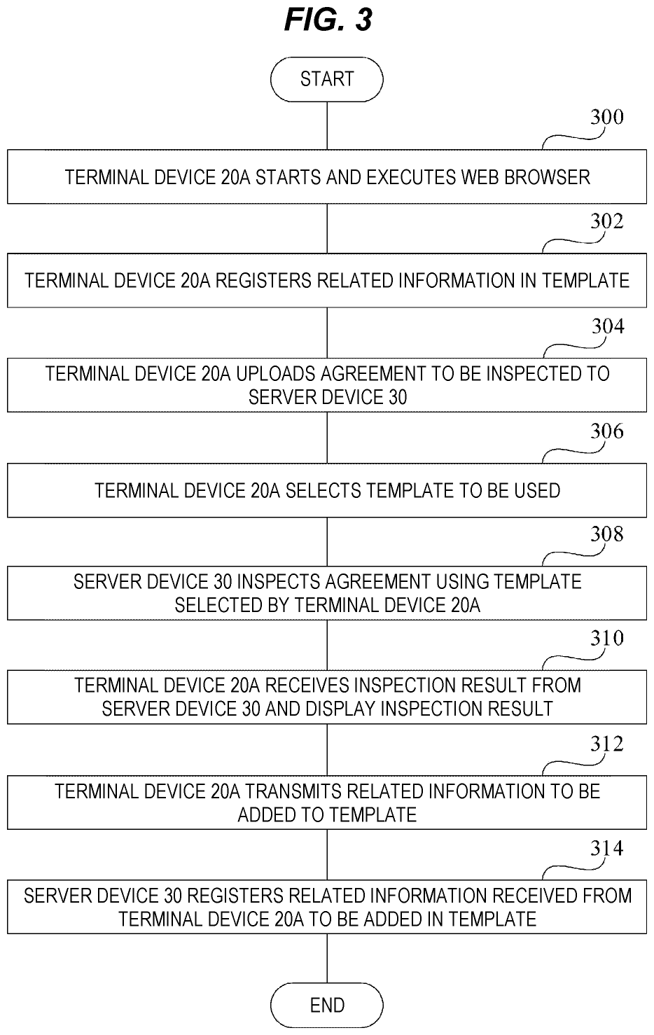

In this manner, for example, by executing the installed web browser, the terminal device 20 can receive a web page from the server device 30 and display the web page (and furthermore execute computer programs included in the web page), and execute various operations related to the document creation service (including various operations to be described below with reference to FIG. 3, etc.). Alternatively, the terminal device 20 can execute similar operations by executing the installed dedicated application.

The terminal device 20 can also include one or more microprocessors (that are processors) and/or one or more graphics processing units (GPUS) (that are processors) instead of the central processing device 21 or together with the central processing device 21.

### (2) Hardware Configuration of Document Creation Server Device 30

An example of a hardware configuration of the document creation server device 30 will be described with reference to FIG. 2. As a hardware configuration of the document creation server device 30, for example, a hardware configuration similar to the hardware configuration of the terminal device 20 described above can be used. Therefore, reference signs for components included in the document creation server device 30 are shown in parentheses in FIG. 2.

As illustrated in FIG. 2, the document creation server device 30 can include a central processing device 31 that is a processor, a main storage device 32, an input/output interface device 33, an input device 34, an auxiliary storage device 35, and an output device 36. These devices may be connected to each other by a data bus and/or a control bus.

The central processing device 31, the main storage device 32, the input/output interface device 33, the input device 34, the auxiliary storage device 35, and the output device 36 can be substantially the same as the central processing device 21, the main storage device 22, the input/output interface device 23, the input device 24, the auxiliary storage device 25, and the output device 26 included in the terminal device 20 described above, respectively.

In such a hardware configuration, the central processing device 31 can sequentially load the instructions and data (computer programs) comprising the specific application stored in the auxiliary storage device 35 into the main storage device 32 and operate the loaded instructions and data. Accordingly, the central processing device 31 can control the output device 36 via the input/output interface device 33, or can transmit and receive various types of information (data) to and from another device (e.g., the terminal device 20 or the like) via the input/output interface device 33 and the communication network 10.

Accordingly, the document creation server device 30 can function as a web server by executing the installed specific application. Accordingly, the document creation server device 30 can execute various operations related to the document creation service (including operations to be described below with reference to FIG. 3, etc.) via a web page transmitted to each terminal device 20 (and furthermore computer programs included in the web page to be executed by the terminal device 20). Alternatively, the document creation server device 30 can function as an application server by executing the installed specific application. As a result, the document creation server device 30 can execute similar operations.

The document creation server device 30 can also include one or more microprocessors (that are processors) and/or one or more graphics processing units (GPUS) (that are processors) instead of the central processing device 31 or together with the central processing device 31.

### 3. Example of Operation of Document Creation System

Next, a specific example of an operation of the document creation system 1 will be described with reference to FIG. 3. FIG. 3 is a flowchart illustrating an example of an operation executed in the document creation system illustrated in FIG. 1.

First, in step (hereinafter referred to as “ST”) 300, a terminal device 20A of a certain user (here, “user A”) can start and execute a web browser installed according to the operation of the user A. The terminal device 20A can access the server device 30 by designating a URL unique to the document creation service.

Furthermore, the terminal device 20A may receive an input of user identification information (user ID) and a password already given to the user A or to a company or the like to which the user A belongs based on an operation of the user A. By transmitting the identification information and the password input in this manner to the server device 30, the terminal device 20A can be authenticated by the server device 30. As a result, the server device 30 transmits a web page comprising a menu screen to the terminal device 20A, so that the terminal device 20A can display the menu screen although not illustrated.

Although not described in detail below for convenience of description, the terminal device 20A can acquire information corresponding to the operation performed by the user A via the input device 24 (a keyboard, a mouse, a touch panel, and/or the like). By transmitting the information corresponding to the operation to the server device 30, and receiving a web page comprising a screen corresponding to such information from the server device 30, the terminal device 20A can display the screen according to the operation. Alternatively, by processing the information corresponding to the operation performed by the user A according to a program included in the web page and/or another program installed in the terminal device 20A, the terminal device 20A can display a screen according to the operation. As a result, every time the user A performs an operation, the terminal device 20A can display a screen according to the operation.

In ST302, the terminal device 20A can select a menu for editing or registering a template from the menu screen based on an operation by the user A. Here, the template may refer to a contract prepared in advance (e.g., “a confidentiality agreement”, “a basic transaction agreement”, “an outsourcing agreement”, “a sales agreement”, or “a lease agreement”).

Here, as an example, a case where the user A edits the template corresponding to the confidentiality agreement will be described. The terminal device 20A can read the template corresponding to the confidentiality agreement among the plurality of templates stored by the server device 30 based on the operation of the user A.

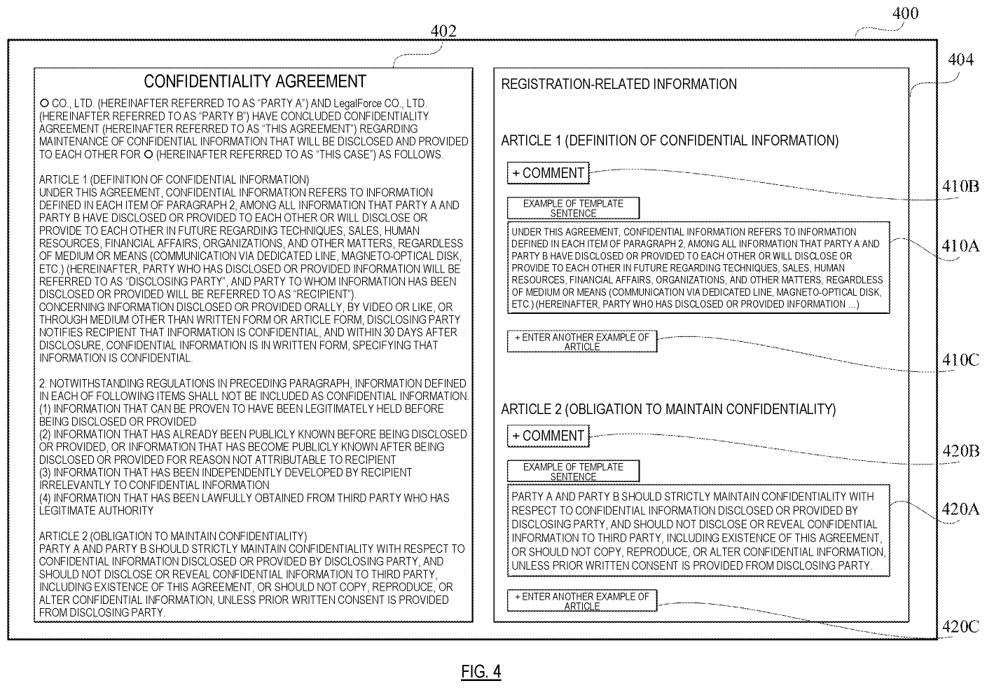

FIG. 4 is a schematic diagram illustrating an example of a screen displayed by the terminal device 20A included in the document creation system illustrated in FIG. 1. As illustrated in FIG. 4, the terminal device 20A can display a screen 400 including a template corresponding to a confidentiality agreement. For example, each article included in the template can be displayed in a left portion 402 of the screen 400, and for example, registration-related information included in the template can be displayed in a right portion 404 of the screen 400.

Although an example in which only Articles 1 and 2 are displayed is illustrated in the left portion 402, the terminal device 20A can display any article included in this template in the left portion 402 according to an operation performed by the user A.

As exemplified in the right portion 404, the registration-related information included in this template can include at least one type of basic related information (here, “an example of template sentence”) 410A preset as the information related to Article 1. The registration-related information included in this template may include another type of basic related information preset as the information related to Article 1. The another type of basic related information can include information indicating explanation with respect to Article 1 (this also corresponds to one type of basic related information) and/or information indicating points to be noted with respect to Article 1 (this also corresponds to one type of basic related information).

Similarly, the registration-related information included in this template can include at least one type of basic related information (here, “an example of template sentence”) 420A preset as the information related to Article 2. Although not shown in FIG. 4, the registration-related information included in this template may include another type of basic related information preset as the information related to Article 2. The another type of basic related information can include, information indicating explanation with respect to Article 2 (this also corresponds to one type of basic related information) and/or information indicating points to be noted with respect to Article 2 (this also corresponds to one type of basic related information).

In this manner, this template can store at least one type of basic related information preset in association with each of a plurality of articles as information related to the article.

In a state in which the screen 400 exemplified in FIG. 4 is displayed, for example, the user A can register one type of additional related information related to Article 1 in the template by clicking an object 410B “+ comment” displayed to correspond to Article 1. Specifically, as the user A clicks the object 410B or the like and inputs characters in a window (not illustrated) displayed on the screen 400 using a keyboard, the terminal device 20A can register information related to Article 1 (information or the like to be noted for Article 1) as one type of additional related information. The information registered by clicking the object 410B “+ comment” or the like can be information indicating a revision policy such as from what viewpoint the article (here, Article 1) should be reviewed.

Additionally or alternatively, in a state in which the screen 400 exemplified in FIG. 4 is displayed, for example, as the user A clicks an object 410C “+ enter another example of article” displayed to correspond to Article 1, the terminal device 20A can register one type of additional related information related to Article 1 in the template. Specifically, as the user A clicks the object 410C or the like and inputs characters in a window (not illustrated) displayed on the screen 400 using a keyboard, the terminal device 20A can register information related to Article 1 (information or the like indicating another example of article related to Article 1) as one type of additional related information. The information registered by clicking the object 410C “+ enter another example of article” or the like can be information indicating an article to be necessarily substituted in a case where the article (410A) in the template cannot be used.

Regarding Article 2, similarly to Article 1, as the user A clicks an object 420B “+ comment” and/or an object 420C “enter another example of article” displayed to correspond to Article 2, the terminal device 20A can register information related to Article 2 (information or the like to be noted for Article 2 and/or information or the like indicating another example of article related to Article 2) as at least one type of additional related information.

As described above, this template can store each of a plurality of articles in association with at least one type of basic related information preset as information related to the article and at least one type of additional related information input as information to be added in relation to the article by the terminal device 20A of the user A. In another embodiment, this template can store each of a plurality of articles in association with at least one type of basic related information preset as information related to the article “and/or” at least one type of additional related information input as information to be added in relation to the article by the terminal device 20A of the user A.

Each piece of the additional related information input by the user A using the terminal device 20A is transmitted to the server device 30 by the terminal device 20A and stored in the server device 30. As a result, the server device 30 can store the edited template (for example, in association with user identification information of the user A). The template edited in this manner can store each of a plurality of articles in association with at least one type of basic related information preset as information related to the article and at least one type of additional related information input as information to be added in relation to the article by the terminal device 20A of the user A (for example, at certain timings including ST302, ST314, etc.). In another embodiment, this template can store each of a plurality of articles in association with at least one type of basic related information preset as information related to the article “and/or” at least one type of additional related information input as information to be added in relation to the article by the terminal device 20A of the user A (for example, at certain timings including ST302, ST314, etc.).

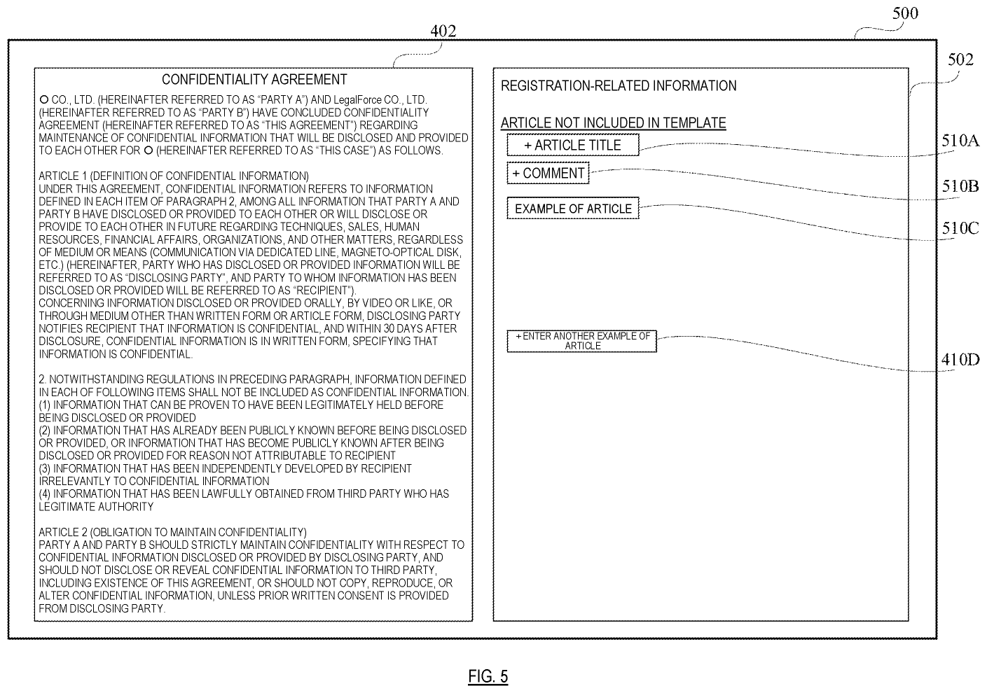

Furthermore, in an embodiment, as illustrated in FIG. 5, the user A (the terminal device 20A that operates based on an operation of the user A) can also register at least one type of basic related information and/or at least one type of additional related information for an article not existing in the template.

FIG. 5 is a schematic diagram illustrating another example of a screen displayed by the terminal device 20A included in the document creation system illustrated in FIG. 1.

In a case where a specific article is missed on the screen 400 illustrated in FIG. 4, the user A can also move to a screen 500 illustrated in FIG. 5 using the terminal device 20A, and register the specific article, and at least one type of basic related information related to the specific article and/or at least one type of additional related information related to the specific article.

For example, each article included in the template can be displayed in a left portion 402 of the screen 500, and for example, registration-related information included in the template can be displayed in a right portion 502 of the screen 500. The information displayed on the left portion 402 can be the same as the information in FIG. 4. Note that the left portion 402 itself may not be displayed.

As exemplified in the right portion 502, in a state in which the screen 500 is displayed, for example, as the user A clicks an object 510A “+ article title”, the terminal device 20A can register one type of basic related information related to this specific article in the template. Specifically, as the user A clicks the object 510A or the like and inputs characters in a window displayed on the screen 500 using a keyboard, the terminal device 20A can register information related to this specific article (information indicating a title or the like corresponding to this specific article) as one type of basic related information.

Additionally, as the user A clicks an object 510B “+ comment” or the like, the terminal device 20A can register one type of additional related information related to this specific article in the template. Specifically, as the user A clicks the object 510B or the like and inputs characters in a window displayed on the screen 500 using a keyboard, the terminal device 20 can register information related to this specific article (information or the like to be noted for this specific article) as one type of additional related information.

Additionally or alternatively, as the user A clicks an object 510C “+ example of article” or the like, the terminal device 20A can register one type of basic related information related to this specific article in the template. Specifically, as the user A clicks the object 510C or the like and inputs characters in a window displayed on the screen 500 using a keyboard, the terminal device 20A can register information related to this specific article (information or the like indicating an example of this specific article) as one type of basic related information.

Additionally or alternatively, as the user A clicks an object 510D “+ enter another example of article” or the like, the terminal device 20A can register one type of additional related information related to this specific article in the template. Specifically, as the user A clicks the object 510D or the like and inputs characters in a window displayed on the screen 500 using a keyboard, the terminal device 20A can register information related to this specific article (information or the like indicating another example of this specific article) as one type of additional related information.

Each piece of the basic related information and/or the additional related information input by the user A using the terminal device 20A may be transmitted to the server device 30 by the terminal device 20A and stored in the server device 30. As a result, the server device 30 can store the edited template (for example, in association with user identification information of the user A). The template edited in this manner can store each of a plurality of articles in association with at least one type of basic related information preset as information related to this article (and furthermore at least one type of basic related information input as information related to this article by the terminal device 20A of the user A) and at least one type of additional related information input as information to be added in relation to this article by the terminal device 20A of the user A (for example, at certain timings including ST302, ST314, etc.). In another embodiment, this template can store each of a plurality of articles in association with at least one type of basic related information preset as information related to this article (and furthermore at least one type of basic related information input as information related to this article by the terminal device 20A of the user A) “and/or” at least one type of additional related information input as information to be added in relation to this article by the terminal device 20A of the user A (for example, at certain timings including ST302, ST314, etc.).

Returning to FIG. 3, in ST304, the terminal device 20A can upload (transmit) an agreement to be inspected (inspection target document) to the server device 30 based on an operation of the user A. The server device 30 can store the inspection target document received from the terminal device 20A.

The server device 30 can store in advance a plurality of templates that can be used to inspect the inspection target document. The plurality of templates may include templates registered and/or edited by the server device 30 in ST302.

In ST306, the server device 30 can transmit, to the terminal device 20A, a web page including a screen (for example, in a pull-down format) for enabling the user A to select which one of the plurality of templates stored in advance is to be used. The terminal device 20A can select a template to be used for inspecting the agreement from among the plurality of transmitted templates based on the operation of the user A. In response thereto, the terminal device 20A can transmit information indicating the template selected by the user A to the server device 30. As a result, the server device 30 can recognize the template selected by the user A.

In another embodiment, the server device 30 can automatically select one of the plurality of templates stored in advance. For example, the server device 30 can identify and select one template (for example, assuming that a type to which the inspection target document belongs is a first type, one template belonging to the first type or one template belonging to another type similar to or related to the first type) related to the inspection target document received from the terminal device 20A in ST304 among the plurality of templates. In order to realize this, the server device 30 can store information for identifying a type to which each of the plurality of templates belongs, and furthermore store information for identifying a type to which the inspection target document belongs. The server device 30 can also generate information for identifying types to which a plurality of templates and/or inspection target documents belong based on information received from the terminal device 20 of one user.

In ST308, the server device 30 can inspect the agreement (inspection target document) using the template selected by the user A (alternatively, the template selected by the server device 30).

Hereinafter, for convenience of description (also in the claims originally attached to the request for application), for the purpose of distinguishing between a plurality of articles included in the template and a plurality of articles included in the inspection target document, the plurality of articles included in the template will be referred to as “a plurality of first articles”, and the plurality of articles included in the inspection target document will be referred to as “a plurality of second articles”.

Briefly speaking, in a first step, the server device 30 can first calculate a degree of relevance between each of the plurality of second articles included in the inspection target document and each of the plurality of first articles included in the template. Next, in a second step, the server device 30 can select one first article related to each of the plurality of second articles included in the inspection target document, from among the plurality of first articles included in the template, based on such a degree of relevance. Further, in a third step, for each of the plurality of second articles included in the inspection target document, the server device 30 can determine registration-related information (basic related information and/or additional related information) associated with the selected one related first article as information to be displayed on the terminal device 20A as a subject terminal device.

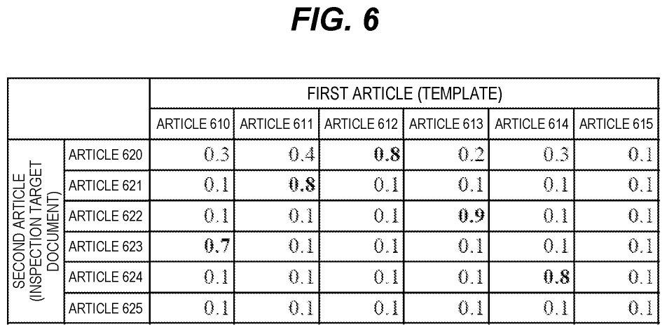

First, the first step will be focused on. FIG. 6 is a diagram for conceptually explaining an example of an inspection performed on an inspection target document in the document creation system illustrated in FIG. 1. In FIG. 6, for the purpose of simplifying the description, an example is illustrated in which the template includes Article 610 to Article 615 as a plurality of first articles, and the inspection target document includes Article 620 to Article 625 as a plurality of second articles.

As illustrated in FIG. 6, the server device 30 can calculate a degree of relevance between Article 620 included in the inspection target document and each of Article 610 to Article 615 included in the template. For example, regarding a degree of relevance between Article 620 and Article 610, an editing distance between these articles (or a value obtained by multiplying this editing distance by a predetermined coefficient) can be used as the degree of relevance between Article 620 and Article 610. Alternatively, Article 620 and Article 610 can be converted into vectors, respectively, and a degree of cosine similarity between the two vectors (or a value obtained by multiplying the degree of cosine similarity by a predetermined coefficient) can be used as the degree of relevance between Article 620 and Article 610. The degrees of relevance between Article 620 and Article 611 to Article 615 can be similarly calculated.

Using a similar method, the server device 30 can calculate a degree of relevance between each of Article 621 to Article 625 included in the inspection target document and each of Article 610 to Article 615 included in the template.

An example of a degree of relevance calculated by the server device 30 in this manner is illustrated in FIG. 6. In the example illustrated in FIG. 6, a degree of relevance falls within a range of 0 to 1.0. The greater (or smaller) the numerical value of the degree of relevance between two articles, the greater (or smaller) the degree of relevance between these two articles.

Next, the second step will be focused on. Based on the degree of relevance calculated in the first step, the server device 30 can select one related first article from among the plurality of first articles included in the template for each of the plurality of second articles included in the inspection target document.

Focusing on Article 620 included in the inspection target document, for example, the server device 30 can select, from among Article 610 to Article 615 included in the template, Article 612 having a degree of relevance equal to or greater than a predetermined threshold (here, for example, 0.2) and having the highest degree of relevance (0.8) as one related first article. Similarly, with respect to Article 621 included in the inspection target document, the server device 30 can select, from among Article 610 to Article 615 included in the template, Article 611 having a degree of relevance equal to or greater than a predetermined threshold (0.2) and having the largest degree of relevance (0.8) as one related first article. By a similar method, with respect to Article 622 to Article 624 included in the inspection target document, the server device 30 can select Article 613, Article 610, and Article 614 included in the template, respectively, as one related first article.

On the other hand, regarding Article 625 included in the inspection target document, since there is no first article having a degree of relevance equal to or greater than the predetermined threshold (0.2) among Article 610 to Article 615 included in the template, the server device 30 can detect that there is no related first article, that is, detect that Article 625 included in the inspection target document is not related to any article included in the template.

Meanwhile, as described above, the server device 30 can detect that Article 610 to Article 614 included in the template are related to Article 623, Article 621, Article 620, Article 622, and Article 624 included in the inspection target document, respectively. On the other hand, regarding Article 615 included in the template, since there is no article having a degree of relevance equal to or greater than the predetermined threshold (0.2) in the inspection target document, the server device 30 can detect that there is no related article (there is a non-related article). In this manner, the server device 30 can detect, as “an article missed in the inspection target document”, a first article (Article 615) not related to any of the second articles included in the inspection target document, among the plurality of first articles included in the template, based on the degrees of relevance calculated in the first step.

Finally, the third step will be focused on. For each of the plurality of second articles included in the inspection target document, the server device 30 can determine registration-related information (basic related information and/or additional related information) associated with the selected one related first article as information to be displayed on the terminal device 20A as a subject terminal device.

Specifically, with respect to Article 620 included in the inspection target document, the server device 30 can determine, as information to be displayed, registration-related information (basic related information and/or additional related information) associated with Article 612 selected as a related article. Similarly, with respect to Article 621 to Article 624 included in the inspection target document, the server device 30 can determine, as information to be displayed, registration-related information (basic related information and/or additional related information) associated with Article 611, Article 613, Article 610, and Article 614 selected as related articles, respectively.

Furthermore, the server device 30 can determine a first article (Article 615) not related to any of the second articles included in the inspection target document, among the plurality of first articles included in the template, as information to be displayed (information related to “an article missed in the inspection target document”).

Returning to FIG. 3 again, next, in ST310, the server device 30 can generate a web page including a screen indicating a result of the inspection executed in ST308 and transmit the web page to the terminal device 20A.

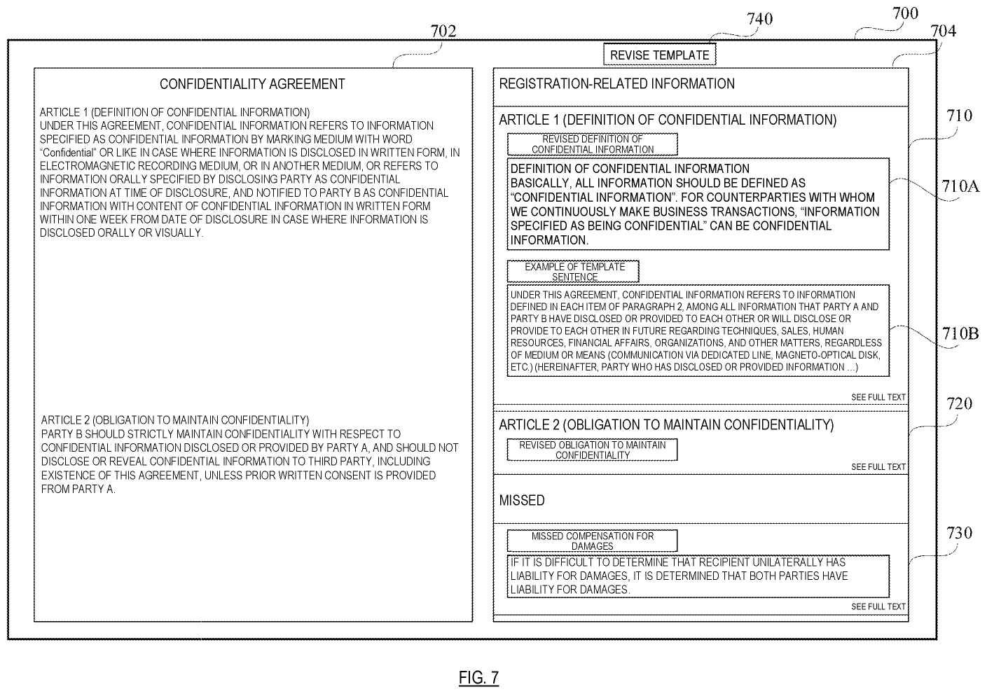

FIG. 7 is a schematic diagram illustrating still another example of a screen displayed by the terminal device 20A included in the document creation system illustrated in FIG. 1. As exemplified in FIG. 7, in a screen 700 displayed by the terminal device 20A, for example, at least a part of an inspection target document is displayed on a left portion 702, and for example, registration-related information (basic related information and/or additional related information) included in a template can be displayed on a right portion 704.

On the left portion 702, a plurality of second articles included in the inspection target document can be sequentially displayed from Article 1. Although an example in which only Articles 1 and 2 are displayed is illustrated in FIG. 7, the terminal device 20A can display any article included in this inspection target document in the left portion 702 according to an operation performed by the user A.

On the right portion 704, in association with each of the plurality of second articles included in the inspection target document, registration-related information associated with a first article included in the template and selected as one related first article for this second article can be displayed. For example, in association with the second article “Article 1” included in the inspection target document, registration-related information associated with the first article “Article 1” included in the template and selected as one first article related to this second article can be displayed in a field 710. Similarly, in association with the second article “Article 2” included in the inspection target document, registration-related information associated with the first article “Article 2” included in the template and selected as one first article related to this second article can be displayed in the field 720. Such a correspondence relationship between each of the plurality of second articles included in the inspection target document and each of the plurality of first articles included in the template is detected from the result of the inspection performed by the server device 30 in step 308.

As a result, the user A can easily review each of the plurality of second articles included in the inspection target document while viewing a first article included in the template in relation to this second article and registration-related information related to this first article (such as recognizing which part of each of the plurality of second articles should be revised and making a revision).

In the field 710, as a specific example of the registration-related information, at least one piece of additional related information (here, for example, one piece of additional related information 710A) registered or edited in ST302, etc. by the user A and/or one piece of preset basic related information (here, for example, one piece of basic related information 710B) can be displayed. For a field 720, at least one piece of additional related information and/or at least one piece of basic related information can be displayed similarly to those for the field 710 as the user A clicks an object “see full text” or the like.

Furthermore, in a field 730, at least one first article (here, an article related to compensation for damages) that is not related to any of the plurality of second articles included in the inspection target document among the plurality of first articles included in the template can be displayed as “an article missed in the inspection target document”, for example, together with at least one piece of registration-related information related to this first article. Such “an article missed in the inspection target document” may be detected from the result of the inspection performed by the server device 30 in step 308 (see Article 615 illustrated in FIG. 6).

In this manner, the terminal device 20A can display the screen 700 as illustrated in FIG. 7 by using the web page received from the server device 30.

In a state where the screen 700 exemplified in FIG. 7 is displayed, the user A may click any portion in the field 710 (the field unique to Article 1) displayed in the right portion 704 or the like, so that the corresponding article (Article 1) in the inspection target document in the left portion 702 is displayed, and the article number and/or article title (definition of confidential information) of the corresponding article (Article 1) in the left portion 702 is highlighted. This similarly may apply to the field 720 displayed in the right portion 704 and fields unique to the other articles not displayed in FIG. 7.

In addition, on the screen 700 for displaying the inspection result exemplified in FIG. 7, a link 740 written as “revise template” for editing and/or registering the template used to inspect the inspection target document displayed in the left portion 702 may be displayed. As the user A clicks this link 740 or the like, the terminal device 20A can display a screen (for example, the screen illustrated in FIG. 4 and/or FIG. 5) for editing and/or registering a template by receiving a new web page from the server device 30, by using information included in an already received web page, by executing a program, or the like. As a result, the user A can edit and/or register the template used for the inspection or another template while reading the inspection result for the inspection target document.

By editing and/or registering the template, the user A can register the additional related information and/or the basic related information to the template using the terminal device 20A. The method may be as described above with reference to FIGS. 4 and 5.

Referring back to FIG. 3, the terminal device 20A can thereby transmit related information to be added to the template (at least one piece of additional related information and/or at least one piece of basic related information) to the server device 30 in ST312.

In response thereto, in ST314, the server device 30 can register the related information to be added (at least one piece of additional related information and/or at least one piece of basic related information) received from the terminal device 20A to the corresponding template.

### 4. Modification

In the various embodiments described above, the operation in which the server device 30 calculates a degree of relevance between each of the plurality of second articles included in the inspection target document and each of the plurality of first articles included in the template has been described.

The “plurality of second articles” mentioned here are not necessarily “all” of the second articles included in the inspection target document. That is, the “plurality of second articles” may be some or all of the second articles included in the inspection target document. Similarly, the “plurality of first articles” are not necessarily “all” of the first articles included in the template. That is, the “plurality of first articles” may be some or all of the first articles included in the template.

Furthermore, in the above-described various embodiments, the case where the terminal device 20A of the user A uses related information edited and/or registered by the terminal device 20A of the user A (and the template in which this related information is registered) to inspect the inspection target document has been described. However, a terminal device 20 of each user can also use related information edited and/or registered by any one of the terminal devices 20 of one or more other users, including the user himself/herself (preferably sharing a user identification number and a password), (and the template in which this related information is registered) to inspect the inspection target document.

Furthermore, in the various embodiments described above, the case where the registration-related information registered in the template can include at least one piece of basic related information and at least one piece of additional related information for each article has been described. However, the registration-related information registered in the template may include at least one piece of basic related information “and/or” at least one piece of additional related information for at least one article.

Furthermore, the server device 30 can prepare a plurality of templates that can be used for inspection for each user. Each of the plurality of templates may be one in which at least partially different registration-related information is associated with each of the plurality of first articles.

Furthermore, in the various embodiments described above, the case in which the user communicates with the server device 30 using the terminal device 20 that executes a web browser to edit and/or register the related information for the template, and execute the inspection with respect to the inspection target document using the template has been described. However, in another embodiment, (the CPU 21 of) the terminal device 20 can execute all of the above-described operations executed by (the CPU 31 of) the server device 30 (that is, an operation of storing a plurality of templates, an operation of editing and/or registering at least one piece of related information for at least one of the plurality of templates, an operation of inspecting an inspection target document using one of the plurality of templates, an operation of generating and displaying a screen showing a result of the inspection, etc.), without communicating with the server device 30.

In still another embodiment, instead of the server device 30, the terminal device 20 can execute some of the operations executed by the server device 30 illustrated in FIG. 3.

Furthermore, in the various embodiments described above, for the purpose of distributing the load applied to the server device 30, some of the operations executed by the server device 30 may be executed by at least one other server device 30.

As will be readily understood by one of ordinary skill in the art having the benefit of the present disclosure, the various examples described above can be used in appropriate combinations with each other in various patterns as long as no contradiction arises.

As described above, according to the technology disclosed in the present application, regarding at least one article, not only related information present in relation to this article but also new related information (various information including comments, examples of articles, and the like) related to this article can be added to each of the templates. Further, the inspection target document can be inspected using the template in which the related information is registered in this way. Furthermore, for each of the plurality of second articles included in the inspection target document, among the plurality of first articles included in the template, a first article related to this second article and related information registered with respect to this first article (including new related information when the new related information exists) can be presented to the user in association with each other.

From the description herein, the disclosure comprises multiple embodiments which include, but are not limited to, the followings:
1. A computer program product according to an aspect “is embodying computer readable instructions stored on a non-transitory computer-readable storage medium for causing a computer to execute a process by at least one processor so as to perform the steps of: selecting one related first article from among a plurality of first articles included in a template for at least one of a plurality of second articles included in the inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and determining, for at least one of the plurality of second articles included in the inspection target document, the registration-related information associated with the selected one related first article as information to be displayed on the subject terminal device”.
2. A server device according to an aspect “includes at least one processor, wherein the at least one processor is configured to execute a computer readable instructions so as to: select one related first article from among a plurality of first articles included in a template for at least one of a plurality of second articles included in the inspection target document based on the degree of relevance; and determine, wherein the template comprises at least one of the plurality of first articles associated with registration-related information including at least one of at least one type of basic related information preset as information related to the first article and at least one type of additional related information received from any terminal device as information to be added in relation to the first article, for at least one of the plurality of second articles included in the inspection target document, the registration-related information associated with the selected one related first article as information to be displayed on the subject terminal device”.
3. A method according to an aspect “for causing a processor to execute a process, the method comprising executing on the processor the steps of: selecting one related first article from among a plurality of first articles included in a template for at least one of a plurality of second articles included in the inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and determining, for at least one of the plurality of second articles included in the inspection target document, the registration-related information associated with the selected one related first article as information to be displayed on the subject terminal device”.
4. A computer program according to another aspect “is embodying computer readable instructions stored on a non-transitory computer-readable storage medium for causing a computer to execute a process by at least one processor so as to perform the steps of: transmitting an inspection target document to a server device storing a template in which at least one of a plurality of first articles is associated with registration-related information including at least one of at least one type of basic related information preset as information related to the first article and at least one type of additional related information received from any terminal device as information to be added in relation to the first article; and receiving, from the server device that calculates a degree of relevance between at least one of a plurality of second articles included in the inspection target document and at least one of the plurality of first articles included in the template and selects one related first article from among the plurality of first articles included in the template for at least one of the plurality of second articles included in the inspection target document based on the degree of relevance, the registration-related information associated with the selected one related first article for at least one of the plurality of second articles included in the inspection target document, and display the received registration-related information”.
5. A terminal device according to an aspect “includes at least one processor, wherein the at least one processor is configured to execute a computer readable instructions so as to: transmit an inspection target document to a server device storing a template in which at least one of a plurality of first articles is associated with registration-related information including at least one of at least one type of basic related information preset as information related to the first article and at least one type of additional related information received from any terminal device as information to be added in relation to the first article; and receive, from the server device that calculates a degree of relevance between at least one of a plurality of second articles included in the inspection target document and at least one of the plurality of first articles included in the template and selects one related first article from among the plurality of first articles included in the template for at least one of the plurality of second articles included in the inspection target document based on the degree of relevance, the registration-related information associated with the selected one related first article for at least one of the plurality of second articles included in the inspection target document, and display the received registration-related information”.
6. A method according to another aspect “for causing a processor to execute a process, the method comprising executing on the processor the steps of: transmitting an inspection target document to a server device storing a template in which at least one of a plurality of first articles is associated with registration-related information including at least one of at least one type of basic related information preset as information related to the first article and at least one type of additional related information received from any terminal device as information to be added in relation to the first article; and receiving, from the server device that calculates a degree of relevance between at least one of a plurality of second articles included in the inspection target document and at least one of the plurality of first articles included in the template and selects one related first article from among the plurality of first articles included in the template for at least one of the plurality of second articles included in the inspection target document based on the degree of relevance, the registration-related information associated with the selected one related first article for at least one of the plurality of second articles included in the inspection target document, and displaying the received registration-related information”.
7. A computer program according to still another aspect “is embodying computer readable instructions stored on a non-transitory computer-readable storage medium for causing a computer to execute a process by at least one processor so as to perform the steps of: storing a template in which at least one of a plurality of first articles is associated with registration-related information including at least one of at least one type of basic related information preset as information related to the first article and at least one type of additional related information selected by a user as information to be added in relation to the first article; acquiring an inspection target document; calculating a degree of relevance between at least one of a plurality of second articles included in the inspection target document and at least one of the plurality of first articles included in the template; selecting one related first article from among the plurality of first articles included in the template for at least one of the plurality of second articles included in the inspection target document based on the degree of relevance; and determining, for at least one of the plurality of second articles included in the inspection target document, the registration-related information associated with the selected one related first article as information to be displayed”.
8. A terminal device according to still another aspect “includes at least one processor, wherein the at least one processor is configured to execute a computer readable instructions so as to: store a template in which at least one of a plurality of first articles is associated with registration-related information including at least one of at least one type of basic related information preset as information related to the first article and at least one type of additional related information selected by a user as information to be added in relation to the first article; acquire an inspection target document; calculate a degree of relevance between at least one of a plurality of second articles included in the inspection target document and at least one of the plurality of first articles included in the template; select one related first article from among the plurality of first articles included in the template for at least one of the plurality of second articles included in the inspection target document based on the degree of relevance; and determine, for at least one of the plurality of second articles included in the inspection target document, the registration-related information associated with the selected one related first article as information to be displayed”.
9. A method according to still another aspect “for causing a processor to execute a process, the method comprising executing on the processor the steps of: storing a template in which at least one of a plurality of first articles is associated with registration-related information including at least one of at least one type of basic related information preset as information related to the first article and at least one type of additional related information selected by a user as information to be added in relation to the first article; acquiring an inspection target document; calculating a degree of relevance between at least one of a plurality of second articles included in the inspection target document and at least one of the plurality of first articles included in the template; selecting one related first article from among the plurality of first articles included in the template for at least one of the plurality of second articles included in the inspection target document based on the degree of relevance; and determining, for at least one of the plurality of second articles included in the inspection target document, the registration-related information associated with the selected one related first article as information to be displayed”.

As a result, the user can centrally manage preset basic related information and additional related information added by any user in the template. Further, by inspecting the inspection target document using this template, the user can quickly and easily confirm, for each of the plurality of second articles included in the inspection target document, a first article related to this second article and related information registered with respect to this first article (including new related information when the new related information exists). Therefore, for example, with respect to the plurality of articles included in the inspection target document, the user can quickly and easily confirm additional related information registered in the company to which the user belongs (which can be said to be related information comprising the review policy in the company) while suppressing a situation in which the additional related information is overlooked. As a result, when the user reviews the inspection target document, it is possible to suppress a situation in which a time to ruminate occurs and/or a situation in which the review policy is missed.

As described above, according to the technology disclosed in the present application, it is possible to provide a computer program, a server device, a terminal device, and a method for supporting agreement creation while improving convenience.

What is claimed is:

1. A computer program product embodying computer readable instructions stored on a non-transitory computer-readable storage medium for causing a computer to execute a process by at least one processor so as to perform the steps of:
selecting one related first article from among a plurality of first articles included in a template for at least one of a plurality of second articles included in an inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and
determining, for at least one of the plurality of second articles included in the inspection target document, the registration-related information associated with the selected one related first article as information to be displayed on the subject terminal device.

2. The computer program product according to claim 1, wherein the processor is further configured to:
detect at least one first article not related to any of the plurality of second articles included in the inspection target document, from among the plurality of first articles included in the template, based on the degree of relevance, and
select the detected at least one first article as the information to be displayed on the subject terminal device.

3. The computer program product according to claim 2, wherein the processor is further configured to select the detected at least one first article as an article missed in the inspection target document.

4. The computer program product according to claim 1, wherein the processor is further configured to:
receive at least one type of new additional related information for one first article designated among the plurality of first articles from the subject terminal device that has received and displayed the registration-related information, and
store a template in which the registration-related information including the new additional related information is associated with the designated first article.

5. The computer program product according to claim 1, wherein the additional related information comprises another example of article different from the first article.

6. The computer program product according to claim 1, wherein the processor is further configured to:
store a plurality of templates, at least partially different registration-related information being associated with at least one of the plurality of first articles in at least one of the templates,
receive the inspection target document from the subject terminal device, and
calculate a degree of relevance between at least one of the plurality of second articles included in the inspection target document and at least one of the plurality of first articles included in the template selected by the subject terminal device or the at least one processor from among the plurality of templates.

7. The computer program product according to claim 1, wherein the processor is further configured to:
store a plurality of templates, and
select the at least one template from the plurality of templates based on a type of the inspection target document.

8. A server device comprising:
at least one processor, wherein
the at least one processor is configured to execute a computer readable instructions so as to:
select one related first article from among a plurality of first articles included in a template for at least one of the plurality of second articles included in an inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and
determine, for at least one of the plurality of second articles included in the inspection target document, the registration-related information associated with the selected one related first article as information to be displayed on the subject terminal device.

9. A method for causing a processor to execute a process, the method comprising executing on the processor the steps of:
selecting one related first article from among a plurality of first articles included in a template for at least one of a plurality of second articles included in an inspection target document based on the degree of relevance, wherein the template comprises at least one of the plurality of first articles associated with registration-related information including at least one of at least one type of basic related information preset as information related to the first article and at least one type of additional related information received from any terminal device as information to be added in relation to the first article; and
determining, for at least one of the plurality of second articles included in the inspection target document, the registration-related information associated with the selected one related first article as information to be displayed on the subject terminal device.
